(19) United States
(12) Patent Application Publication
(10) Pub. No.: US 2025/0242542 A1
(43) Pub. Date: Jul. 31, 2025

(54) METHOD OF DEPOSITING MATERIAL FOR ADDITIVE MANUFACTURING

(71) Applicant: UT-Battelle, LLC, Oak Ridge, TN (US)

(72) Inventors: Halil Tekinalp, Knoxville, TN (US); Seokpum Kim, Knoxville, TN (US); Soydan Ozcan, Oak Ridge, TN (US)

(21) Appl. No.: 19/042,842

(22) Filed: Jan. 31, 2025

Related U.S. Application Data
(60) Provisional application No. 63/627,089, filed on Jan. 31, 2024.

(51) Int. Cl. B29C 64/232; B29C 64/209; B29C 64/236; B33Y 10/00; B33Y 30/00

(52) U.S. Cl. CPC B29C 64/232; B29C 64/209; B29C 64/236; B33Y 10/00; B33Y 30/00

(57) ABSTRACT

A method of depositing material for additive manufacturing of an object includes providing a printhead configured to move linearly along a flat x-y plane parallel to a build surface for the object and configured to simultaneously move in a vertical z-direction that is perpendicular to the x-y plane. The method further includes forming a layer of the object by extruding material from the printhead while simultaneously operating the printhead to move in a printing pattern that includes both a linear component in the x-y plane and a vertical component in the z-direction to deposit a layer of material along a path of the printing pattern. The printing pattern is sinusoidal, sinusoidal-like, partially sinusoidal, or partially sinusoidal-like. The printing pattern compensates for material contraction upon solidification of the formed object, thereby reducing one or both of residual stress in the formed object and distortion of the formed object.

### CROSS-REFERENCE TO RELATED APPLICATIONS

This application claims the benefit of U.S. Provisional Application No. 63/627,089, filed Jan. 31, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to additive manufacturing, and more particularly to a method of depositing material for additive manufacturing of an object.

### BACKGROUND OF THE INVENTION

Additive manufacturing (AM), also known as 3D printing, refers to a process in which an object or part is formed layer-by-layer according to a three-dimensional digital computer model. Most polymer-based additive manufacturing systems utilize thermoplastic polymers as build materials. Thermoplastic-based additive manufacturing systems are easier to operate and more suitable for building tall parts since the deposited thermoplastic material solidifies as it cools down, thereby having a high yield strength. However, the cooling and solidification of previously deposited layers causes residual stress buildup due to thermal expansion and contraction of the material forming the layers. This undesirably can lead to distortion of the printed part. In some cases, the distortion is so severe that the part being printed dislodges from the print bed and the printing process fails. This behavior is much more prevalent when neat polymer feedstocks are used as the build material since they have higher coefficients of thermal expansion (CTE) in comparison to fiber-reinforced polymer feedstocks. This being the case, by way of example one of the main if not most important reasons carbon fibers are added into acrylonitrile butadiene styrene (ABS) polymer feedstocks is to enable large-scale printability of objects with ABS while minimizing warpage during printing. As such, neat polymer feedstocks are generally not suitable for forming large-scale objects by additive manufacturing processes. Therefore, a need continues to exist for additive manufacturing processes that enable the use of neat and/or high-CTE polymers as build materials for large-scale objects. Similar warpage issues can be seen in metal 3D printing processes such as wire-fed 3D printing process.

### SUMMARY OF THE INVENTION

A method of depositing material for additive manufacturing of an object is provided. The method includes providing a printhead configured to move linearly along a flat x-y plane parallel to a build surface for the object and configured to simultaneously move in a vertical z-direction that is perpendicular to the x-y plane. The method further includes forming a layer of the object by extruding material from the printhead while simultaneously operating the printhead to move in a printing pattern that includes both a linear component in the x-y plane and a vertical component in the z-direction to deposit a layer of material along a path of the printing pattern. The printing pattern is sinusoidal, sinusoidal-like, partially sinusoidal, or partially sinusoidal-like. The printing pattern compensates for material contraction upon solidification of the formed object, thereby reducing one or both of residual stress in the formed object and distortion of the formed object.

In specific embodiments, the layer comprises one of a plurality of iteratively deposited layers of an additive build that is formed according to a three-dimensional model, such that the additive build is comprised of successive layers that form the object.

In specific embodiments, the printing pattern is a sinusoidal-like pattern that is a sawtooth pattern.

In particular embodiments, the sawtooth pattern comprises linear peaks and linear valleys alternating between ramped portions.

In specific embodiments, the printing pattern is a partially sinusoidal pattern that comprises a linear component and a sinusoidal component.

In particular embodiments, the partially sinusoidal printing pattern includes a plurality of alternating linear components and sinusoidal components.

In specific embodiments, the printing pattern is a partially sinusoidal-like pattern that comprises a linear component and a sinusoidal-like component.

In particular embodiments, the sinusoidal-like pattern is a sawtooth pattern.

In particular embodiments, the partially sinusoidal-like printing pattern includes a plurality of alternating linear components and sinusoidal-like components.

In specific embodiments, the method further includes the step of controlling movement of the printhead to adjust one or both of a frequency and an amplitude of the printing pattern.

In particular embodiments, the deposited layer is one layer of a plurality of iteratively deposited layers of an additive build according to a three-dimensional computer model, such that the additive build is comprised of successive layers of the deposited material, and the step of controlling movement of the printhead includes decreasing the amplitude of the printing pattern for each successively deposited layer of the additive build.

In particular embodiments, the amplitude of the printing pattern is smaller than a bead height of the deposited material.

In specific embodiments, the material is a polymer, a polymer composite, a metal, a metal alloy, or a metal/alloy composite.

In specific embodiments, the material includes but is not limited to polyethylene, polypropylene, nylon 11, nylon 6, nylon 66, polylactic acid, or acrylonitrile butadiene styrene.

An additive manufacturing device including a printhead is also provided. The printhead is configured to perform the method according to any of the embodiments above.

A method of operating an extrusion printhead to perform an additive manufacturing process is also provided. The method includes operating an actuator with a controller to move one or both of the printhead and a build surface relative to each other, wherein the printhead travels along a predetermined path for one layer of a three-dimensional printed object. While moving the printhead, the method further includes depositing material along the predetermined path to form the one layer in a printing pattern. The printing pattern includes both a linear component in an x-y plane parallel to the build surface and a vertical component in a z-direction perpendicular to the build surface. The predetermined path compensates for material contraction upon solidification of the printed object, thereby reducing one or both of residual stress in the printed object and distortion of the printed object.

In specific embodiments, the one layer is one of a plurality of iteratively deposited layers of an additive build according to a three-dimensional computer model, such that the additive build is comprised of successive layers of the deposited material that form the printed object.

In specific embodiments, the additive manufacturing process is fused deposition modeling, which may alternatively be referred to as fused filament fabrication or melt extrusion deposition.

In specific embodiments, the predetermined path is sinusoidal, sinusoidal-like, partially sinusoidal, or partially sinusoidal-like.

In specific embodiments, the material includes a polymer, a polymer composite, a metal, a metal alloy, or a metal/alloy composite.

In specific embodiments, the material includes polyethylene, polypropylene, nylon 11, nylon 6, nylon 66, polylactic acid, or acrylonitrile butadiene styrene.

In specific embodiments, the printhead is configured to move in the x-direction, the y-direction, and the z-direction for depositing the material in the printing pattern.

In specific embodiments, the printhead is configured to move in the x-direction and the y-direction, and cooperative with the printhead, the build surface is configured to move in the z-direction, for depositing the material in the printing pattern via the cooperative movement of the printhead and the build surface.

These and other features of the invention will be more fully understood and appreciated by reference to the description of the embodiments and the drawings.

### BRIEF DESCRIPTION OF THE DRAWINGS

FIG. 1 is a schematic view of an additive manufacturing device configured to perform a method of depositing material in accordance with embodiments of the disclosure;

FIG. 2 is a schematic view of the method of depositing material illustrating a sinusoidal printing pattern in accordance with certain embodiments of the disclosure;

FIG. 3A is a schematic view of the method of depositing material illustrating a partially sinusoidal printing pattern in accordance with certain embodiments of the disclosure;

FIG. 3B is a schematic view of the method of depositing material illustrating a partially sinusoidal printing pattern in accordance with other certain embodiments of the disclosure;

FIG. 4 is a schematic view of the method of depositing material illustrating relief of internal stresses in the deposited layer upon cooling and contraction;

FIG. 5 is another schematic view of the method of depositing material illustrating relief of internal stresses upon relaxation/contraction;

FIG. 6 is a graph of layers of a conventional printing pattern in accordance with the prior art, for additive manufacturing of an additively built object;

FIG. 7 is a graph of layers of a sinusoidal printing pattern in accordance with certain embodiments of the disclosure, for additive manufacturing of an additively built object;

FIG. 8 is a graph of layers of a sinusoidal-like sawtooth printing pattern in accordance with certain embodiments of the disclosure, for additive manufacturing of an additively built object;

FIG. 9 is a graph of layers of a sinusoidal-like sawtooth printing pattern including linear peak and valley portions in accordance with certain embodiments of the disclosure, for additive manufacturing of an additively built object;

FIG. 10 is a graph of layers of another sinusoidal-like sawtooth printing pattern including linear peak and valley portions in accordance with certain embodiments of the disclosure, for additive manufacturing of an additively built object;

FIG. 11 is a graph of layers of yet another sinusoidal-like sawtooth printing pattern including linear peak and valley portions in accordance with certain embodiments of the disclosure, for additive manufacturing of an additively built object;

FIG. 12 is a graph of layers of another sinusoidal-like sawtooth printing pattern including linear peak and valley portions in accordance with certain embodiments of the disclosure, for additive manufacturing of an additively built object;

FIG. 13 is a graph of layers of another sinusoidal-like sawtooth printing pattern including linear peak and valley portions in accordance with certain embodiments of the disclosure, for additive manufacturing of an additively built object;

FIG. 14A is a side view of warpage of a part printed by a conventional printing method according to the prior art;

FIG. 14B is a side view of warpage of a part printed by a printing method in accordance with embodiments of the disclosure;

FIG. 15 is a graph of warpage of nylon 11 printed parts at various nozzle temperatures formed by a printing method in accordance with embodiments of the disclosure;

FIG. 16 is a graph comparing warpage of control parts printed by a conventional printing method and parts printed by a printing method in accordance with embodiments of the disclosure at various printing speeds and a nozzle temperature of 230° C. using polypropylene as the build material; and

FIG. 17 is a graph comparing warpage of control parts printed by a conventional printing method and parts printed by a printing method in accordance with embodiments of the disclosure at various printing speeds and a nozzle temperature of 230° C. using nylon-11 as the build material.

### DETAILED DESCRIPTION OF THE CURRENT EMBODIMENTS

In conventional polymer-based and metal wire-fed additive manufacturing (AM) processes, the extruded bead of material is deposited as the printhead solely moves linearly in an x-y plane that is parallel to the build surface. Subsequent to the deposition of the layer, the printhead then moves in a vertical z-direction that is perpendicular to the x-y plane to advance to the height for depositing the next linear layer, or the build surface advances a set direction away from the printhead. The residual stress buildup and distortion of the printed part formed by layers of the extruded beads mainly arises from contraction of the linearly deposited bead in the printing direction during cooling, which stresses the underlying, previously deposited, already (relatively) cooled layer. In contrast, in embodiments of the present method disclosed herein, the printhead deposits beads of build material while travelling in a combination of vertical movement in the z-direction together with linear movement along the x-y plane. In other embodiments, the printhead deposits beads of build material while the printhead moves linearly in the x-y plane and a build surface on which the material is deposited moves in the z-direction. The combined x-y-z movement of the printhead or printhead and build surface in a sinusoidal or sinusoidal-like pattern advantageously provides for the uniform deposition of extra build material in the z-direction to compensate for the contraction of the build material upon cooling.

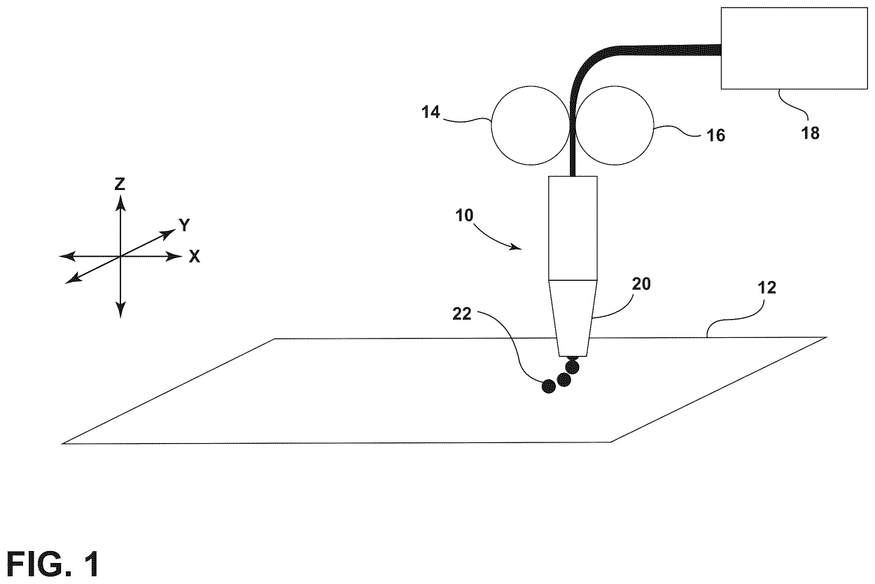

More particularly, as shown schematically by way of example in FIG. 1, an additive manufacturing system and process in accordance with embodiments of the disclosure includes a printhead 10 such as an extrusion printhead. The printhead 10 is coupled to an actuator (not shown) controlled by a controller (not shown) that moves the printhead linearly along a flat x-y plane parallel to a stationary build surface 12 on which a printed object is formed and simultaneously moves the printhead in a vertical up-and-down z-direction that is perpendicular to the x-y plane. In alternative embodiments, the build surface 12 moves in the z-direction cooperatively and in combination with the movement of the printhead 10 in the x-y plane. The controller also actuates a feed mechanism such as feed rollers 14, 16 to feed a printing material filament from a filament feed source 18, such as a spool of filament, to the printhead 10. Within the printhead, the printing material filament is heated by a heating element or similar to melt the material, and the melted material is extruded through a nozzle 20 of the printhead towards the build surface 12 and a bead 22 of the extruded material is deposited to form a layer of the object being printed, which may be referred to as an additive build. In various embodiments, the material is extruded as a continuous bead as shown and described below, rather than in droplets, such that the layer formed is one continuous portion or portions of material. The printhead 10 iteratively deposits a plurality of these layers in succession according to a predetermined path derived from slices of a three-dimensional digital computer model, and the plurality of layers together define the additive build.

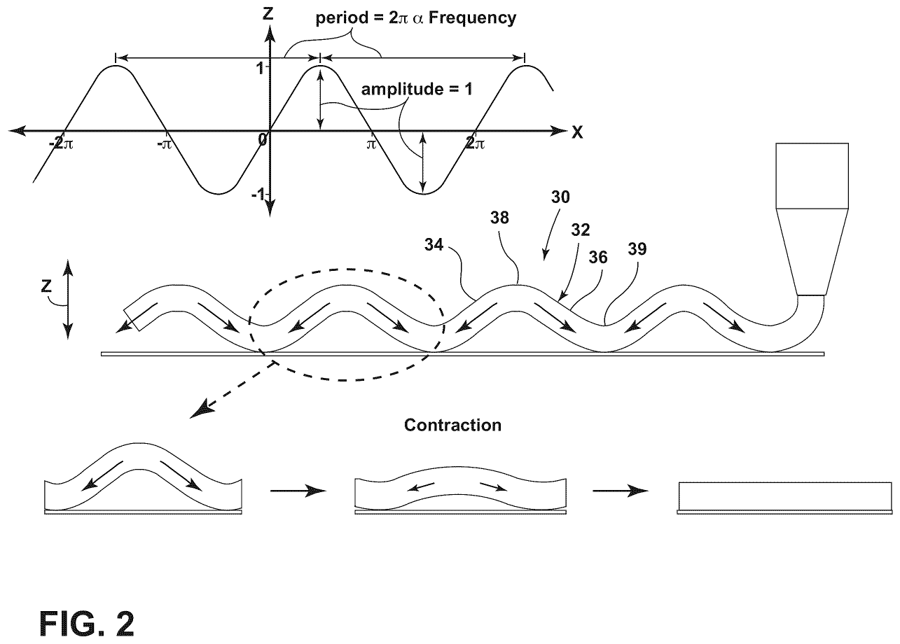

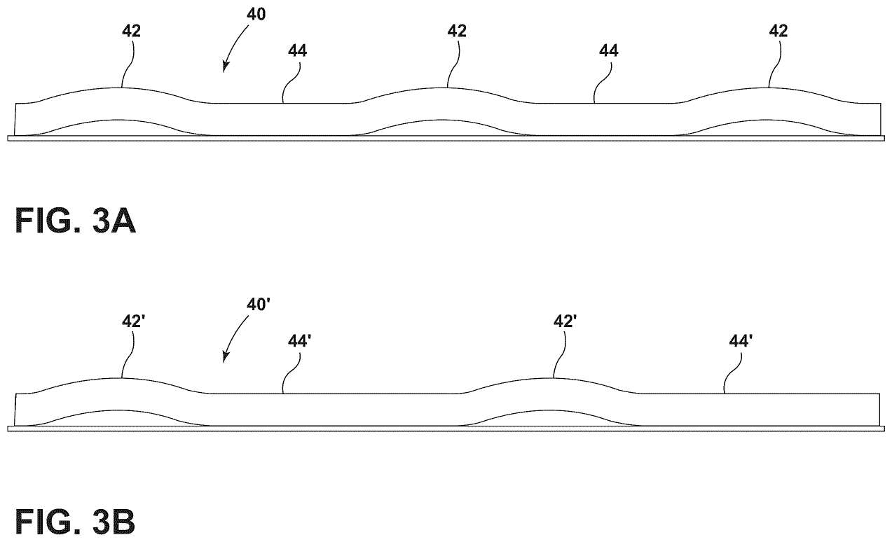

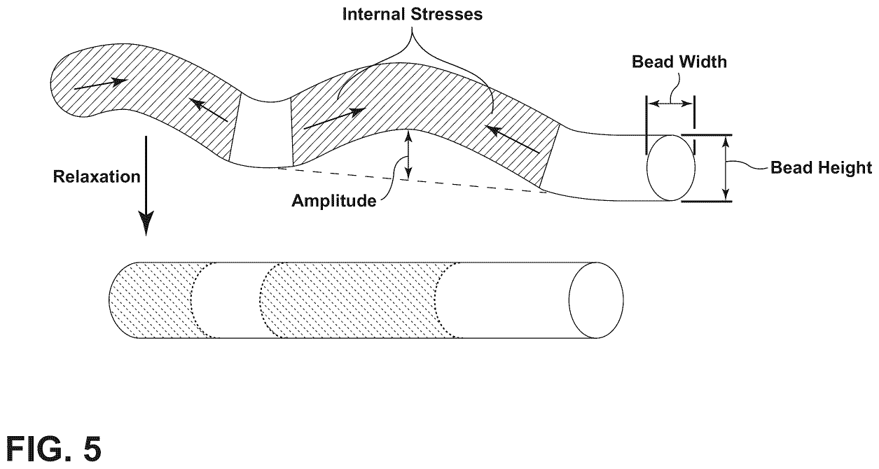

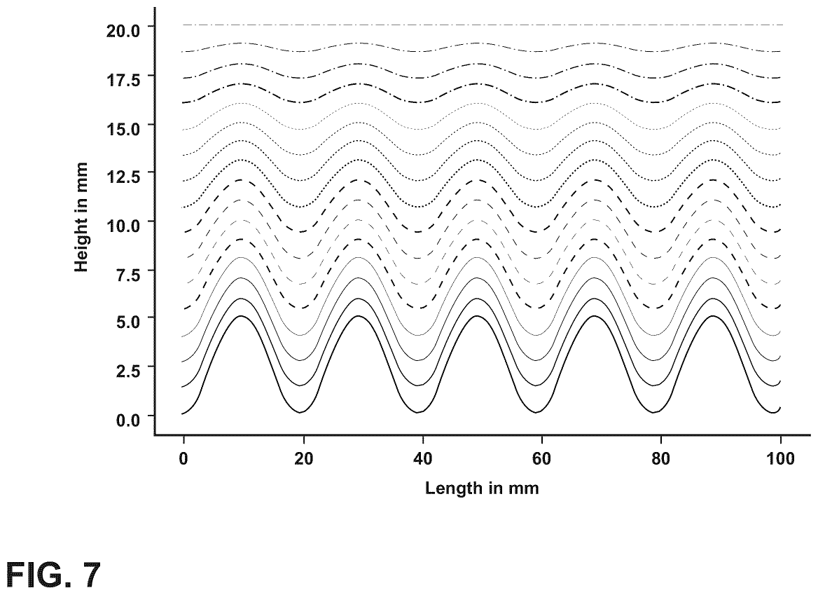

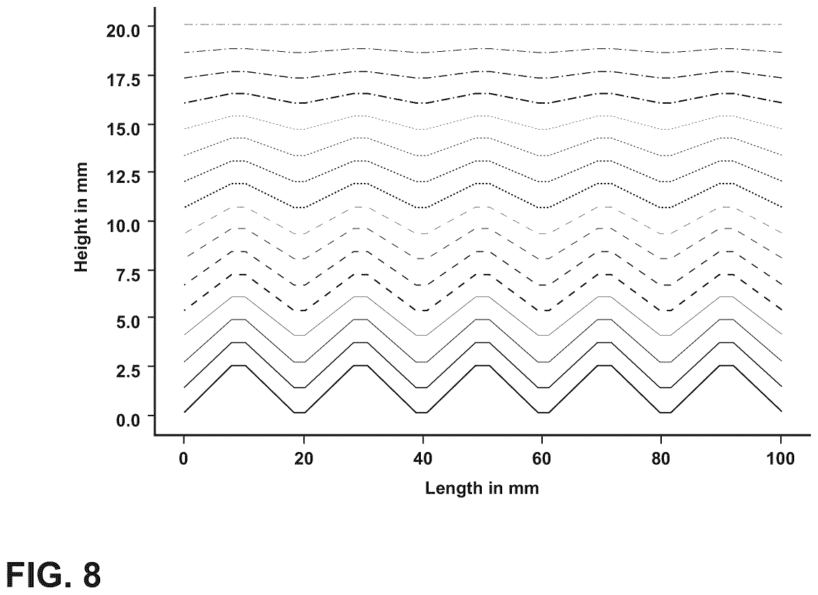

Specifically, each layer of the printed object is formed by extruding material and simultaneously moving the printhead in a printing pattern that includes both a linear component in the x-y plane and a vertical component in the z-direction such that the layer of material is deposited along a path of the printing pattern. In some embodiments, the printhead may be moved by a multi-axis robotic arm, or alternatively by another suitable mechanical actuator that allows the printhead to simultaneously move in the x-y directions as well as the vertical z directions to deposit material in the printing pattern. In other embodiments, the printhead may be moved by an actuator in the x-y directions while another actuator moves the build surface up and down in the z-direction to deposit material in the printing pattern. By moving the printhead or by cooperatively moving the printhead and the build surface in this manner, the printing pattern of deposited material has one of a sinusoidal shape, a sinusoidal-like shape, a partially sinusoidal shape, or a partially sinusoidal-like shape. For example, a sinusoidal printing pattern 30 is shown in FIG. 2. The sinusoidal printing pattern 30 generally has the shape of a sine wave such as that shown, and thus can also be described as a periodic wavy pattern having hills 32 with upward slopes 34 and downward slopes 36, and peaks (crests) 38 and valleys (troughs) 39 between the slopes. As shown schematically at the bottom of the figure, as the layer of sinusoidally-deposited material cools, it contracts to reduce internal stress and flattens into the final desired physical shape. Turning to FIG. 3A, the printing pattern 40 of deposited material may alternatively have a partially sinusoidal shape having a sinusoidal component formed of waves 42 separated by a linear component formed of a linear portion 44. In this example, the length of the linear portions 44 is approximately half the length of the waves 42, and the printing pattern 40 alternates between the waves 42 and the linear portions 44. In another example shown in FIG. 3B, the length of the linear portions 44′ of the partially sinusoidal printing pattern is approximately equal to the length of the waves 42′. In other embodiments such as shown by example in FIGS. 8-13, the printing pattern may have a sinusoidal-like shape such as a sawtooth shape including alternating flat (not curved), linear upwardly-ramped portions and flat (not curved), linear downwardly-ramped portions. In some of these embodiments, the sawtooth pattern includes linear peaks and linear valleys alternating between the ramped portions such that the peaks and valleys of the sawtooth are flattened and elongated. In yet other embodiments, the printing pattern may have a partially sinusoidal-like shape having a sinusoidal-like pattern that is a sawtooth alternating with a linear component. Furthermore, as shown by examples in FIGS. 7-13, movement of the printhead can be controlled to adjust either or both of the frequency (the length of one complete wave or sawtooth) and amplitude (height) of the printing pattern. Also, the amplitude of the printing pattern may be decreased for each successively deposited layer, and the printing pattern may approach a linear pattern as the additive build advances from formation of the first layer to formation of the final layer of the additive build. Moreover, as shown in FIG. 5, the amplitude of the printing pattern may be set to be smaller than the bead height of the extruded, deposited material.

The material extruded from the printhead and used to form the deposited layers may be a polymer, a polymer composite such as a polymer impregnated with carbon fibers, a metal, a metal alloy, or a metal or metal alloy composite. Examples of suitable polymer materials for use in the method include but are not limited to polyethylene (PE), polypropylene (PP), polylactic acid (PLA), acrylonitrile butadiene styrene (ABS), and polyamides such as nylon 11 (PA11), nylon 6 (PA6), or nylon 66. The material may include only one polymer, or a mixture of two or more polymers. The polymer material may also include one or more compatibilizers or other additives. In other alternatives, the material may include one metal, a mixture of two or more metals, one metal alloy/composite, a mixture of two or more metal/alloy composites, or combinations thereof. In certain preferred embodiments, the method is particularly suitable for neat polymers such as polyamides (e.g., nylon 11) and polyalkylenes (e.g., polypropylene) that have a high coefficient of thermal expansion (CTE) and thus are more prone to distortion when heated and then allowed to cool.

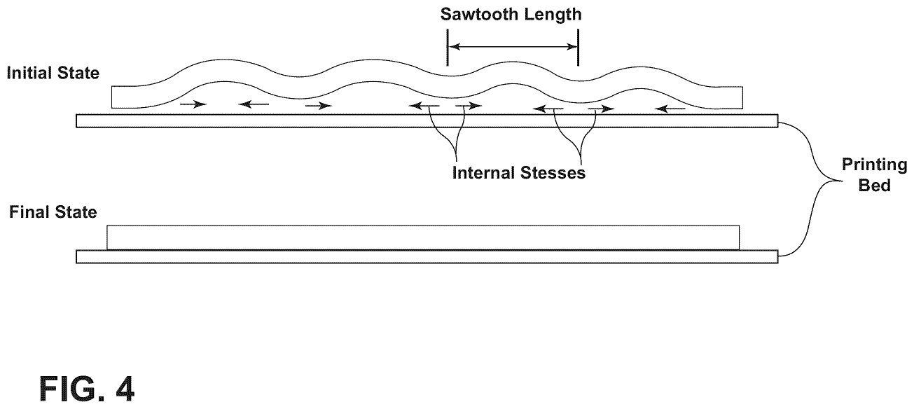

As described in more detail in the examples below and as shown schematically in FIG. 4, the printing pattern compensates for material contraction upon solidification of the formed object and thus reduces residual stress in the formed object and/or physical distortion of the formed object. The method including depositing build material in the printing pattern may be applied to additive manufacturing processes such as fused deposition modeling (FDM), which may also be referred to as fused filament fabrication (FFF) or melt extrusion deposition (MED).

### Examples

The present method is further described in connection with the following laboratory examples, which are intended to be non-limiting.

Typically, a conventionally-formed 3D printed part consisting of uniformly stacked layers will show more deformation toward its base than at the top, as the base is closer to the heating bed and the lower layers are under greater pressure from the weight of those above. In contrast, in the present method, by introducing selective and uniform gaps in the base of the part, the beads of deposited thermoplastic material can contract and fill the gaps to relieve the internal residual stresses, without compromising structural integrity. As shown in FIGS. 4 and 5, a bead deposited in accordance with the present method undergoes deformation vertically, instead of facing shrinkage along its length. Hence, warpage in the specimen part can be avoided. The extra material added to the specimen part can also improve rigidity and density of the individual layers, which also aides in resisting deformation.

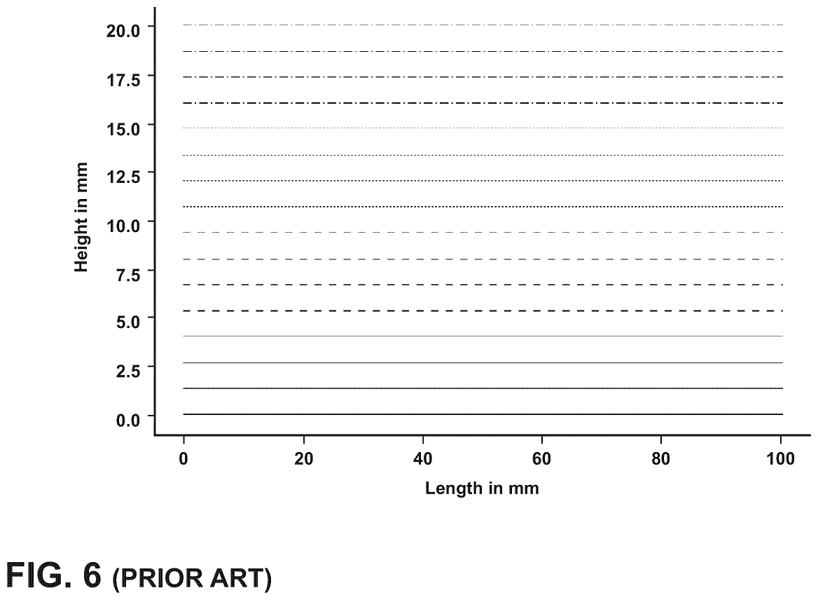

To illustrate the method, first a wall-like structure (with rectangular cross-section) was modified. One requirement for the printed part is continuity, specifically the wall should have periodic gaps at the bottom, but gradually tend towards a perfectly straight profile with each consecutive layer. The initial approach for this included finding an algorithm for producing a series of sinusoidal functions, with continuously decreasing amplitudes in each new layer. For example, the user may simply define the number of layers N, the maximum amplitude A (the amplitude of the function in the first layer) and the total height H of the structure. For comparison, functions for a linear, straight toolpath having uniform straight layers in accordance with the prior art are shown in FIG. 6, whereas derived functions of a modified toolpath in accordance with the present method having varied sinusoidal amplitudes are shown in FIG. 7. As shown, H is equal to 20 mm, A is equal to 5.0 mm, and N is equal to 16.

Starting with a basic functional form of fₙ(x)=Aₙ Cos(x)+Zₙ, where n is the index denoting a current printing layer, ranging from n=1 to n=N−1, the coordinates are oriented such that the length of the part is aligned along the x-axis, the width extends along the y-axis, and the height extends along the z-axis. Both the amplitude and displacement height of each function in the series have to change with n and depend on each other. Using the boundary conditions that a minima should exist at the edges of the part (for support) and that there be a constant difference between the troughs and a smaller constant difference between the peaks, (such that the ratio between the two is constant), it can be shown that Zₙ=Aₙ−(0.5) A₁+nh where h is the constant difference in amplitude between the peaks. Further, h follows the function h=(H−A)/(N−1) and Aₙ=Anh/(H−A)=An/(N−1). This gives a final functional form fₙ(x)=Ah/(H−A)[n Cos(x)+n−0.5]+nh=A(n Cos(x)+n−0.5)/N+n(H−A)/N. This series of functions yields the results shown in FIG. 7.

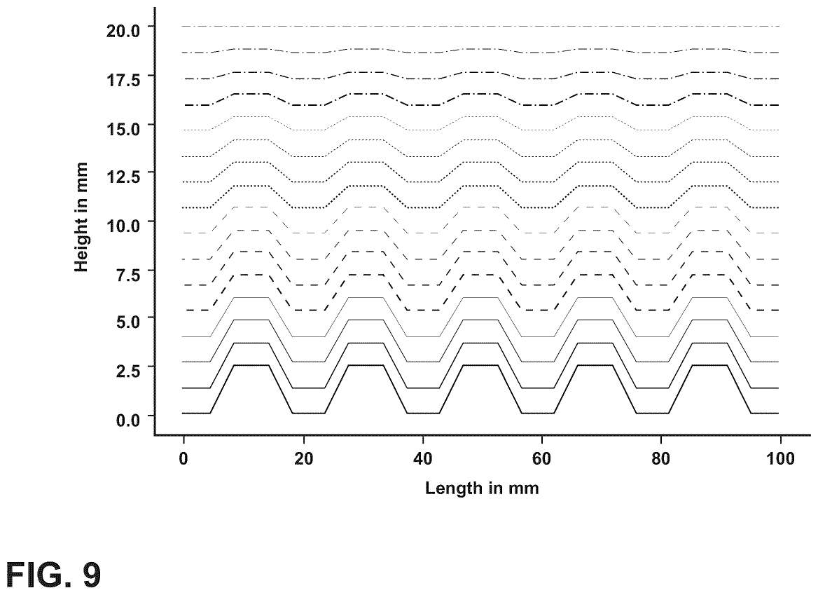

As a modification, the toolpath next was altered from a sinusoidal function to a sinusoidal-like sawtooth function. Sawtooth patterns can be easier movements for the printhead to make in comparison to sinusoidal arcs. Also, in order to lay filament material across the entire height of each sinusoidal wave, the thickness of the extruded material may have to change continuously. This is because the gap between the peaks of the waves in each consecutive layer, although aligned with respect to phase, may be narrower than those between troughs. In fact, in order to get a function that starts off as sinusoidal and gets progressively flatter, more material should be added to the minima and less to the maxima. Such a modified, sawtooth function is shown in FIG. 8. The sawtooth function is a much simpler toolpath for a printhead to follow because it does not have any arcuate portions. As an additional modification to the sawtooth pattern, flat or level base and peak segments can be added to the sawtooth pattern between the linear increasing and linear decreasing segments as shown by example in FIG. 9. Such a further modified sawtooth function can give the resulting layered, printed structure a firmer base, improving stability. In both of these functions shown, H is equal to 20 mm, A is equal to 2.5 mm, N is equal to 16, and M (the number of teeth) is equal to 5.

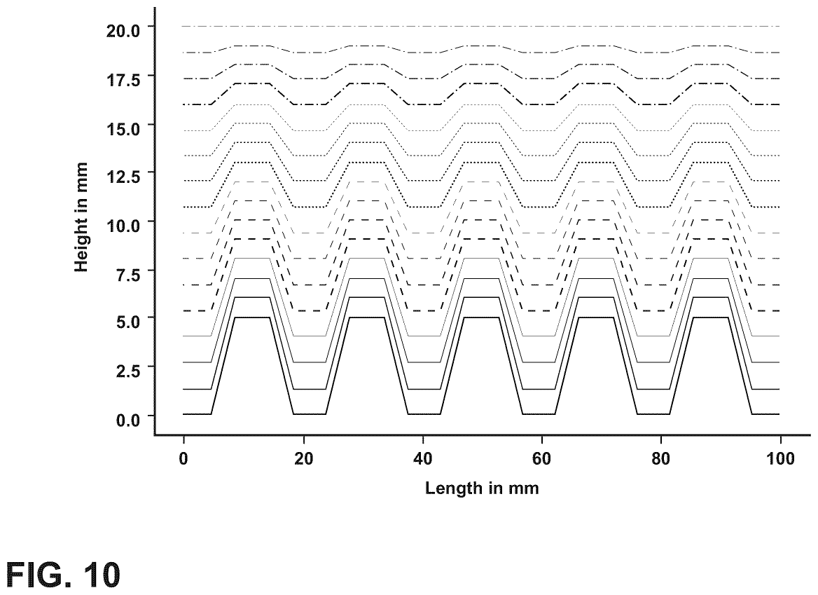

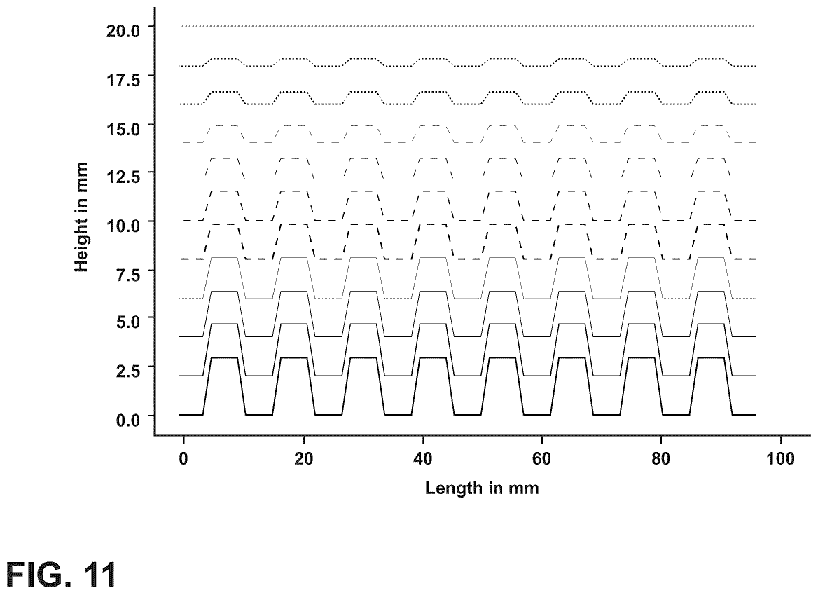

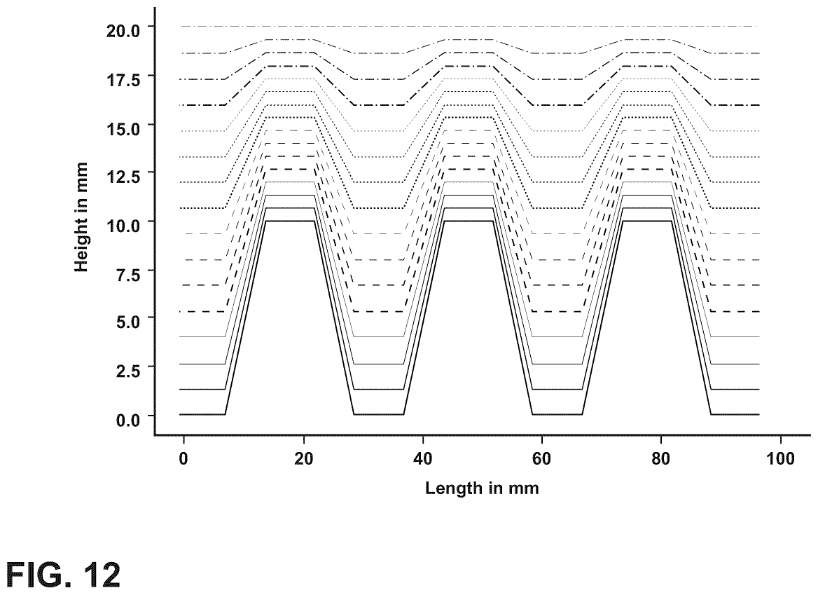

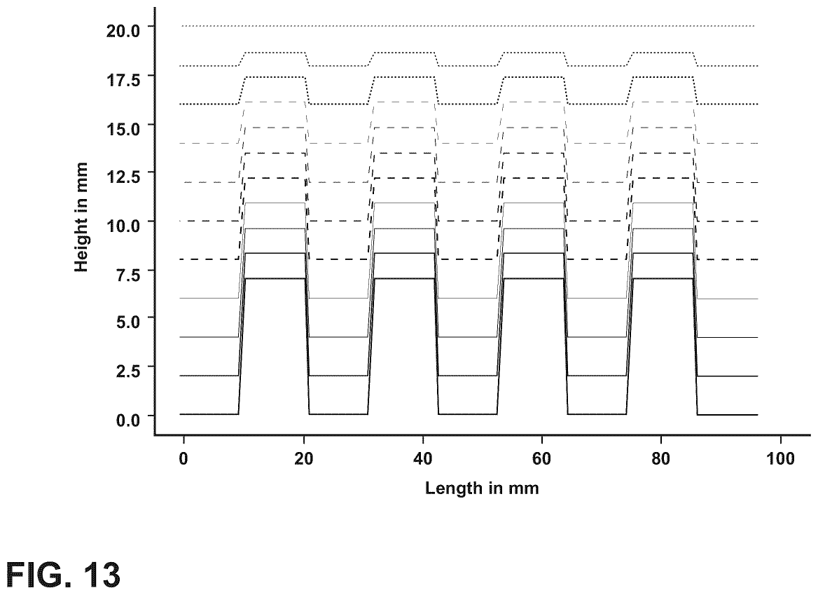

By defining a new parameter M which is the number of teeth, the saw teeth can be defined as having the functional form fₙ(x)=2MAx/LN+cₙ on the increasing slopes of the saw teeth in which z is increasing, and fₙ(x)=−2MAx/LN+cₙ+2A on the decreasing slopes, wherein cₙ=(H−A)n/N+−Aₙ/N. The user selected parameters give a tremendous variety of different structural forms the sawtooth shape can take to fit specific individual applications. The voids can be increased by using a greater amplitude A, with the number of teeth M increased or decreased. Further, the overall number of layers N can be chosen. Examples of the sawtooth functions are shown in FIGS. 10-13 in which the height H of the printed part is fixed at 20 mm. In FIG. 10, the amplitude A of the teeth is set at 5 mm, the number of layers N is set at 15, and the number of teeth M is set at 5. In FIG. 11, the amplitude A of the teeth is set at 3 mm, the number of layers N is set at 10, and the number of teeth M is set at 8. In FIG. 12, the amplitude A of the teeth is set at 10 mm, the number of layers N is set at 15, and the number of teeth M is set at 3. In FIG. 13, the amplitude A of the teeth is set at 7 mm, the number of layers N is set at 10, and the number of teeth M is set at 4.

The saw teeth with flat bases are more easily defined in relative coordinates, and much easier to program into g-code, requiring the printhead nozzle to move the same amount along x and y for a given layer. The changes in x remain the same for subsequent layers, and all that changes is the height of the teeth in that layer. The algorithm for this toolpath movement in relative coordinates may be constructed as follows. Let a=A/N, and b=L/4M. Then follow these steps: 1) Start at left-hand corner origin (0,0,0); 2) Move along x by +b/2 units; 3) Move along x by +b units and y by +a(N−n) units; 4) Move along x by +b units; 5) Move along x by −b units and y by +a(N−n) units; 6) Move along x by +b/2 units; 7) Move along y by b units; 8) Repeat steps 3-7, but exchange +b/2 for −b/2 in steps 3, 5 and 7; 9) Move along y by −b units; 10) If Z=H, then stop, otherwise proceed to step 11; 11) Lift nozzle through Z by H/(N−1) unit; and 12) Repeat steps 3-12 for every layer (N times total). Parsing this into Gcode and including basic initialization and safety headers, a python script may be written to reproduce the above tool path for given user defined parameters A, H, L, M, N, and feed rate F. When this Gcode is given to, for example, a Mach3 CNC interpreter, it can produce a simulated tool path in accordance with the present method.

Even with sawtooth toolpath functions with flat bases, there still may be a need for constant width variation between the floor and ceiling of each saw tooth layer. If a constant width is chosen for the diagonal movement portions of the tool path, this may introduce gaps (in the case of under-filling) or misalignment (in the case of overfilling). To counter this, the diagonal movements may be made in several steps of increasing width and height connecting the base and roof of each tooth. Also, the feed rate of material may be varied to artificially change the filament thickness as required.

Next, printing tests were performed using nylon and polylactic acid (PLA) to demonstrate baseline warpage that is present in cuboid geometries with different dimensions and processing speeds. Fused deposition modeling (FDM) filaments were used to print the parts with a 3D printer (MakerGear Mk3). First, a sample with dimensions of 50 mm×8.8 mm×25 mm (Length×Width×Height) was printed using a conventional printing approach. However, because of the high thickness, observed warpage in the part was insignificant. Thus, another part was printed with only 1.25 mm height. To achieve this height, printing was stopped after the fifth layer of deposition. In this case, a significant amount of warpage was observed. To study the effect of thickness on warpage, another manufacturing was performed in which the thickness of the part was kept at 5 mm, making its dimensions to be 50 mm×8.8 mm×5 mm. Furthermore, to study the warpage behavior in wider plates, manufacturing was performed for a plate with dimensions of 100 mm×32.3 mm×1.25 mm. Again, a considerably high warpage was observed.

All of these were manufactured using PLA. PLA has flexibility in its behavior, and this may have reduced the effect of temperature variation observed during manufacturing. Hence, manufacturing was also performed using a high CTE thermoplastic material, specifically nylon. Nylon is far more sensitive to temperature because of its high coefficient of thermal expansion. For this case, the dimensions of the manufactured part were kept to 120 mm×4.4 mm×2.5 mm. Longer and thinner specimens were used to further enhance the effect of temperature variation and to perform a detailed study on the warpage of the specimen. A summary of the manufactured parts described above is shown in Table 1 below. In total, five different samples were produced by changing their dimensions or the material used for manufacturing. Except for the first case, i.e., a thick specimen, all the other specimens suffered from a considerably high warpage. This suggests a need for manufacturing methods which can reduce the warpage without the need for any additional processing to be implemented on the printed parts after printing has been done. Using the present sinusoidal printing approach, warpage in the manufactured specimens can be reduced significantly.

TABLE 1
Warpage of various parts manufactured
using a conventional printing approach

| Part | | | |
|---|---|---|---|
| No. | Material | Dimensions | Comment |
| 1 | PLA | 50 mm × 8.8 mm × 25 mm | Thick specimen |
| 2 | PLA | 50 mm × 8.8 mm × 1.25 mm | Thin specimen |
| 3 | PLA | 50 mm × 8.8 mm × 5 mm | Medium thickness |
| | | | specimen |
| 4 | PLA | 100 mm × 32.3 × 1.25 mm | Wide specimen |
| 5 | Nylon | 120 mm × 4.4 mm × 2.5 mm | High CTE long and |
| | | | thin specimen |

Next, printing tests were performed using nylon and PLA to verify that the present toolpath improves (lessen) warpage, while varying parameters to find optimal values with the chosen dimensions. The printed sample parts showed that using the sawtooth toolpath for the deposited beads increased the stiffness and rigidity of the part compared to an equivalent control piece without the toolpath adjustment. Further, it was observed that the dimensions of the part were a significant factor in the degree of warpage. All the parts tested had bead widths of 0.55 mm and layer heights of 0.25 mm. A nozzle width of 0.5 mm was used to extrude the plastic.

For 100-layer parts with dimensions of 50 mm×8.8 mm×25 mm (Length×Width×Height) no appreciable effect on warpage was observed, similar to the control pieces which exhibited very little warpage. When the number of oscillations was lowered such that the length of each oscillation was 25% or more of the total length of the piece, greater bed adhesion was observed, but this mainly may be attributed not to the release of internal stresses but to greater contact area with the printing bed. However, for the same parts but interrupted in their fifth layer (1.25 mm in height), significant warpage was observed in the control case, and warpage was eliminated for teeth 10% of the length of the whole part, with saw teeth having an amplitude of 0.5 mm (FIG. 8). For proportionally wider parts (100 mm×32.3×1.25 mm) similar results were observed, this time for saw teeth of 1 mm amplitude but each oscillation still at 10% the total length of the part (FIG. 9). It appeared that without the additional strength afforded by a much proportionally taller and denser part, the effects of warpage were much more pronounced, but with the present toolpath this distortion was reduced to less than 1 mm.

For printed parts at 5 mm height but with the same 50 mm×8.8 mm footprint, the number of teeth was gradually increased and the corresponding warpage reduction was measured. Although the warpage was at most approximately 20% reduced from the control case, it was not eliminated for teeth number ranging from 4 to 10 (10%-25% of total length); the amount of warpage reduction stayed the same. In other words, for these dimensions and sawtooth amplitude, the warpage reduction was independent of number of oscillations. The inflexibility of PLA may have disguised the real effects of warpage. Thus, for further testing the material was switched to nylon, which is far more prone to warpage. The examples show that using all these materials, the present method is viable for small scale printing with amplitudes at the 1 mm scale. The added stiffness does indeed resist the effects of internal stress forces, reducing curling warpage deformation. Although implementing the present method invariably increased the printing time, it was proved that if a conventional linear toolpath is artificially slowed down, there is more warpage—so improvement is not just an artifact of parameter effects like flow speed and feed rate which are known to affect warpage. The present method may be utilized on other materials, especially those more prone to warpage like high CTE composites. Furthermore, the present sinusoidal-type deposition toolpath was shown to work best for amplitudes smaller than the bead height. For increasingly fine resolution, the warpage was correspondingly reduced. However, additional material properties such as viscosity may have to be taken into account. The present method may be applied for other high CTE polymers and crystalline materials. Ideally, the material should be flexible and viscous enough to completely flatten and release the internal stresses before it solidifies.

In the examples described and discussed above, the focus was to generate a G-code which could synthesize the present vertical sinusoidal deposition pattern, which was written in python using Marlin specs. The code was fully parameterized such that quantities like the frequency of oscillations (M), amplitude of the oscillations (A), part geometry (height, width, length) as well as processing parameters (print speed, flow rate, extrusion temperature) could all be specified as inputs by the user, and as an output the code produced the G-code which generated the part using the deposition pattern. This was successfully validated using tests with PLA, nylon and ABS, though degree of warpage improvement varied for each material. To further validate the present method, the specific parameter optimizations were investigated for different materials, starting with high CTE neat polymers (polypropylene and nylon 11). Material filaments of this type are rare as commercial standards, so FDM filaments of these materials were first made in laboratory.

A Filabot EX2 (110V) was used to complete a three-stage system including filament extruding, cooling, and spooling. Starting with pellets, this system was used to develop high CTE polymer filaments (polypropylene and nylon 11) to use in FDM. The first of the three connected stages was the ‘Filament Extruder’ module. The Filabot extruder has settings of extrusion temperature, which is determined with a PID temperature controller, a drive setting, which determines the RPM of the extruding screw, and a power switch. Pellets are fed into the hopper at the top, which fall into the extrusion chamber and are melted into semi-fluid state, then compressed and pushed through the metal nozzle (aperture width of 1.75 mm) into a thin continuous filament. For making polypropylene (PP) filaments, the process started with ExxonMobil pellets (PP3155) with the material specifications shown in Table 2 below. The extrusion was found to be most consistent at a temperature setting of 185° C., which is 15° C. above the stated melting point temperature of these PP pellets (in a range 140° C.-170° C. according to the manufacturer), and a driver setting of 2.75. Additionally, nylon (PA 11) filaments were prepared in the same manner with pellets from Arkema (Rislan PA11), with the physical material properties also shown in Table 2. This material required a higher extrusion temperature of 200° C., and a ‘Extrusion’ driver setting of 3.

TABLE 2
Material Properties of the Polypropylene and Nylon 11 Pellets

| | | Melting | | Bulk | Pellet |
|---|---|---|---|---|---|
| | Density | Point | MFR | Density | Size |
| Material | (g/cm³) | (C.) | (g/10 min) | (kg/m³) | (μm) |
| Polypropylene | 0.89-0.92 | 140-170 | 36 | 400-700 | 100 |
| Nylon 11 | 0.46-0.63 | 183-188 | 0.55 | 400-600 | 110 |

The second Filabot stage, known as the ‘Airpath’ module, consists of a series of six fans, which blow continuous cold air onto the filament to cool it quickly to room temperature, and five small U-shaped magnets. These magnets guide the filament from the nozzle over the fans and into the third Filabot stage in which spooling takes place. The fan setting is a simple power setting from 0 to 100% output. For polypropylene, the optimal setting for fan speed corresponded to a 71% power output, for the denser nylon filament, the optimal setting was 75%.

The third stage ‘Spooler’ module took the cooled filament and wound it around ‘500-gram’ 50 cm diameter standard spools, which when full correspond to roughly 500 feet of filament. With 1 Kg of pellets, three full spools of PP and two full spools of PA 11 filament were produced at a rate of 10 grams/minute each. In this stage, the filament was first guided through two vertically suspended wheels which compressed and helped solidify the filament and additionally provided tension to sufficiently draw out the filament from the extruder without sagging and sticking to the cooling Airpath module stage, which otherwise causes bunching of the filament. Once through these two wheels, the filament next passed through a fish-eye guide, which is connected to a motor, controlled by a traverse speed setting on the third stage. This motor drives a screw which pulls the guide in the ‘transverse’ direction, or rather, perpendicularly to the line of the filament, which allows the filament to be spooled evenly, as opposed to every winding wrapping around the same point. Finally, the filament was wound onto the spool, which rotates at a given RPM again determined by the ‘Driver’ control on the stage module and related to the ‘Extrusion’ drive speed (to maintain tension along the length between extruder nozzle and spooler). For PP the correct Driver setting was experimentally found to be 11.75, corresponding to an RPM of 10, and a setting of 9.25 (RPM of 9.88) and was found for PA 11. After sufficient cooling, the polypropylene filament had a consistent diameter-approximating the target of 1.75 mm. Nylon had more deviation from 1.75 mm-closer to 1.5 on average.

Next, printing was optimized to reduce warpage of curl bars printed on a desktop scale. For printing these filaments, experimental ranges of printing parameters ranges were determined based on literature values. These parameters were namely printing speed, nozzle temperature, and printing bed temperature. The associated values are shown in Table 3 below. The specified curl bar geometries (length, width, height) of 150 mm×3.3 mm×2.5 mm (10 layers) where modelled in TinkerCad and sliced, with the processing parameter specifications applied in Cura.

TABLE 3
Processing parameters for printing
neat PP and PA 11 filaments in FDM

| | Nozzle | Bed | Printing | |
|---|---|---|---|---|
| | Temperature | Temperature | Speed | |
| Material | (° C.) | (° C.) | (mm/s) | Adhesion Type |
| Polypropylene | 165-250 | 23-25 | 20-60 | Polypropylene |
| | | | | Tape |
| Nylon 11 | 240-290 | 23-50 | 25-50 | PVA, Magigoo, |
| | | | | Garolite, 3DLac |

In conventional FDM printing approaches, operation temperatures are closely tied to material properties, and typical parts are printed on the desktop scale with a large range of speeds, often up to 100 mm/s, but may include slower initial layers to increase bed adhesion. Additionally, slurries, glue-sticks, brims, and rafts may all be included or excluded optionally to increase bed adhesion, and their necessity is predicated on specific part geometries. For example, the presence of overhangs may require more supports. To limit the range of variables and to ensure a fairer comparison to the present method, for this series of experiments brims or rafts were not used, but a polypropylene-based tape was utilized to help the control part stick to the surface. Also, it was determined which bed temperatures provided the best additional adhesion with both slower initial layers and constant layer speeds for all layers.

Based on initial testing, a bed temperature of 60° C. was determined for use in all subsequent experiments, including the testing of the present method. The optimal printing speed and nozzle temperature, however, were still varied over the full ranges ascertained from literature values, in order to find the best pair of these values which minimized the warpage for Cura sliced curl bars, all with the same geometry and total layers specified previously. The same approach was taken for testing curl bar warpage when using PA 11, also with the same dimensions, with the exception that in initial testing the best bed adhesion and part consistency was seen for an unheated bed and no tape. Therefore, these parameters were kept the same while nozzle temperature and printing speed were varied as with PP, and the corresponding warpages measured. The travel speeds were kept consistent (100 mm/s) for all parts (control case and with sinusoid toolpath) and materials.

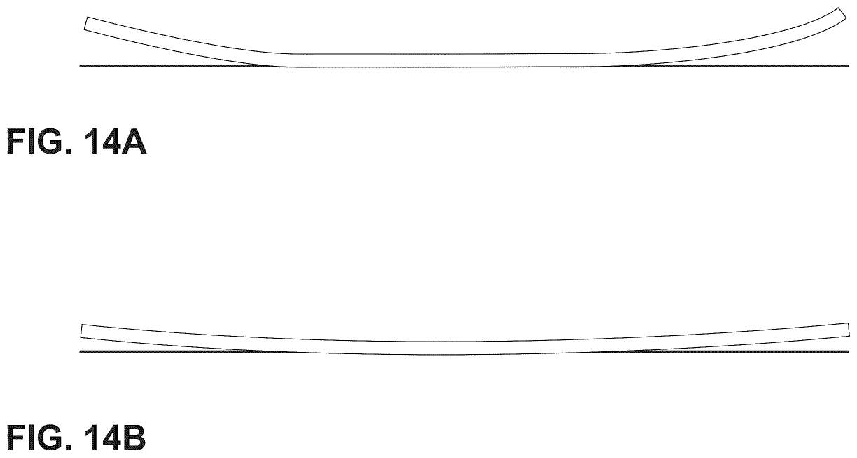

For determining the measurement of distortion, measurements were made by aligning the base of the curl bars with a mm grid, then measuring the deflection of the ends against this grid taking the middle point of each face to be in the center of the end corners. The level of uncertainty was at most half the resolution of the grid, which was equivalent to ±0.5 mm. An example for PP is shown in FIGS. 14A-B, which are line drawings taken from photographs of actual printed parts. The printed part illustrated in FIG. 14A was printed according to conventional FDM printing, with a printing speed of 60 mm/s and a nozzle temperature of 230° C. Using the same parameters, the printed part illustrated in FIG. 14B was printed according to the present method with a sinusoidal amplitude of 0.125 mm and a frequency of 47 cycles/m. The part printed according to the present method had 58% less warpage. The maximum, minimum, and average warpages in mm of the Face Center Point (FCP) from the print bed are shown in Table 4, for every temperature/printing speed pair. Furthermore, the average warpage for each printing speed and each temperature is shown separately. For the range of temperatures and speeds tested, in the case of PP it was found that warpage is minimized at print speeds of 40 mm/s and nozzle temperatures of 230° C., with an average of 4.31 mm and a minimum of 1.5 mm. The average warpage at 230° C. across all printing speeds was 7.61 mm, which is the minimum of every temperature tested. Additionally, the average warpage for 40 mm/s prints across the full temperature range was 11.70 mm, which also was the minimum of all the printing speeds tested. If initial slower layers are used (8 mm/s first layer, 24 mm/s second layer), the warpage is reduced further, but only by a small amount. The overall PP average warpage was 10.42 mm.

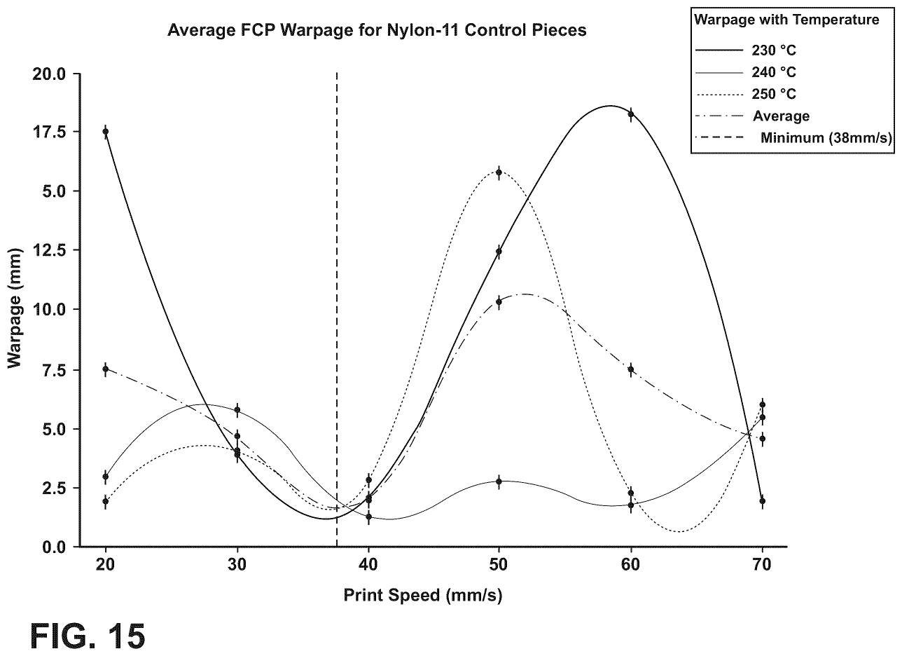

When testing PA 11 parts, it was found that warpage is minimized at print speeds of 40 mm/s and nozzle temperatures of 240° C., with an average of 1.25 mm. The average warpage across the full range of print speeds at 240° C. was 3.33 mm, the smallest for every temperature tested. Additionally, as shown in FIG. 15, the average warpage for 40 mm/s prints across the full temperature range was 3 mm, which also was the minimum average of all the printing speeds tested. Comparing these with the values of warpage measured with the polypropylene control parts, substantially less warpage was observed than with the nylon. Overall, for nylon average warpage was 6.06 mm, again substantially less (42%) than with polypropylene.

TABLE 4
Average Face Center Point to bed Distance (Warpage)

| | Average Face Center Point to bed Distance (Warpage) | | | | | | |
|---|---|---|---|---|---|---|---|
| | in Millimeters for Nylon/PA 11 Control Parts | | | | | | |
| | Printing Speed (mm/s) | | | | | | |
| | | | | | | | Mean |
| | | | | | | | Warpage at |
| Temp. (C.) | 20 mm/s | 30 mm/s | 40 mm/s | 50 mm/s | 60 mm/s | 70 mm/s | Temp. |
| 230 | 17.5 | 4 | 2 | 12.4 | 18.25 | 2 | 8.81 |
| 240 | 3 | 5.75 | 1.25 | 2.75 | 1.78 | 5.50 | 3.33 |
| 250 | 2 | 4 | 2.75 | 15.75 | 2.25 | 6 | 5.34 |
| Mean | 7.5 | 4.58 | 3.00 | 10.81 | 7.43 | 4.5 | 6.06 |
| warpage at | | | | | | | |
| speed | | | | | | | |

Next, optimal processing parameter values were studied for neat, high-CTE polymers, in this case PA 11 and PP. Such neat, high-CTE polymers such as PA 11 and PP are typically considered unprintable, but the present sinusoidal or sinusoidal-like toolpath, by providing vertical, out-of-plane deposition of material, offsets shrinkage. The same toolpath and same curl bar part geometry were used as with the control/base cases above, and optimization began with the same processing parameters and toolpath parameter values from the Nylon and PLA examples.

First, optimal printing speeds for PP and PA 11 at fixed amplitude were investigated. The particular values which minimize warpage distortion can vary considerably with material parameters, even with different types of nylon such as polycaprolactam vs. polyamide-11. The temperature was fixed at 230° C., because this was the optimal value in the control case above. Subsequent experiments also showed little difference in warpage for the control pieces across a range of temperatures. For curl bars of similar dimensions (120 mm×4.4 mm×2.5 mm), it was found that warpage was minimized at a sinusoidal amplitude of 0.125 mm and frequency of 125 cycles per meter (15 oscillations for a 120 mm part). However, for nylon 11 and a longer curl bar (150 mm×2.5 mm×3.3 mm) it was found that a modified frequency of 100 cycles per meter (15 oscillations over 150 mm) was not the ideal value. For polypropylene, when comparing pieces with the same geometry and a fixed printing speed and temperature, a range of sinusoidal frequencies was tested, and it was found that 7 oscillations, corresponding with a frequency of 47 cycles per meter, minimized the warpage. This was less than half as many as PA 11 and just over a third of the value for the other type of nylon.

It was clear from the testing that the present toolpath was more reliable and the parts more robust with a large variety of printing parameters. Across the full range of printing speeds, from 20 mm/s to 110 mm/s, the warpage of the sinusoidal pieces still remained very small—between 2 and 4.75 mm for PP and between 1.5 and 4.25 mm for nylon. If this is compared to the ranges of warpage for the corresponding control pieces, the values of the control pieces are between 6.75 and 12.75 mm and 3 and 10.8 mm for PP and PA 11, respectively. The results are summarized in Table 5 below. For PP parts, it was found that like the control pieces, the present sinusoids generally printed better with a heated bed. The most successful prints occurred at 60° C., with the best single part printed with a 65° C. bed. In all cases, however, as with the control pieces polypropylene-based tape was required to keep the beads adhering long enough to form layers. For PA 11 by contrast, it was found that an unheated bed and no tape was better. For PP, the sinusoid with the least Face Center Point (FCP) warpage was 2 mm, produced with print speeds of 40 mm/s, a printing temperature of 230° C., and an amplitude of 0.125 mm. For nylon 11, a printing speed of 60 mm/s optimized the printing, with a higher temperature of 250° C. required to minimize the warpage to a value of 1.5 mm. At these parameter values, the corresponding pair of control parts had FCP warpages of 5 mm and 2.25 mm; therefore, the warpage was reduced from the control case by 60% and 34% for PP and PA 11, respectively.

TABLE 5
Average warpage as a function of printing speed Average Warpage
for PP and PA 11 Curl Bars at various Printing Speeds

| | Printing Speed | | | |
|---|---|---|---|---|
| Material | 20 mm/s | 40 mm/s | 50 mm/s | 60 mm/s |
| polypropylene | 12.61 | 11.70 | 12.75 | 6.75 |
| nylon 11 | 7.5 | 3.00 | 10.81 | 7.43 |

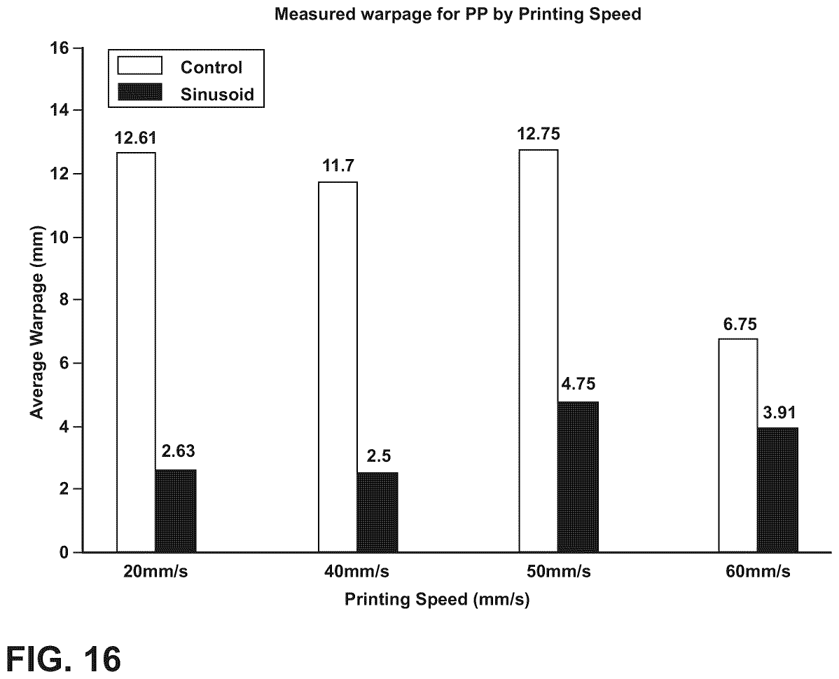

In summary, the examples demonstrate printing of a 2 to 4 mm wide, 150 mm long curl bar with a desktop scale 3D printer using a high-CTE neat polymer such as nylon 11 or polypropylene and a sinusoidal or sinusoidal-like toolpath according to the present method achieves a 40% decrease in warpage distortion compared with a conventional printing approach. As shown in FIG. 16, for polypropylene if the warpage of the best performing control part is compared against the best sinusoidal part, a sufficient reduction in warpage from 3.5 mm to 2 mm was shown, which corresponds to a 42% reduction. But here the best control part had an advantage by being printed at a slower speed, 27 mm/s. If the best sinusoid part is compared to a control part formed with the same print speed (and same overall print time), warpages as high as 7 mm were observed, and at an average of 4.31 mm. The present method is therefore a 41% improvement for the average sinusoidal part printed at these speeds and temperatures, which typically have warpages of 2.56 mm, and a 71% improvement in the best case. This result is reproduced across the full range of printing speeds and temperatures tested, with sinusoidal parts warping 2-5 mm, showing similar improvements in warpage percentage reduction to the base case. For example, PP control parts at 60 mm/s printing speed and 230° C. nozzle temperature had average warpages of 6.88 mm, whereas the average sinusoidal part with the same processing parameters had a warpage of 3.9 mm, or still a reduction of 43% in comparison to the control. When the best sinusoidal part in this range (2 mm) is compared to the worst control part (9.5 mm), and a reduction of 79% was observed. Additionally, the best five sinusoidal parts had 29% less warpage on average than the best five control case parts.

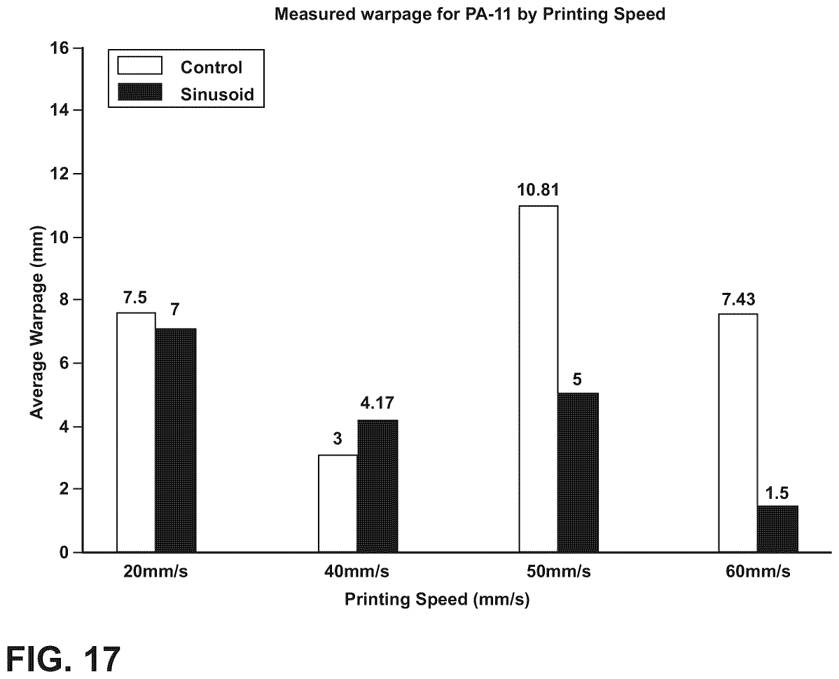

As shown in FIG. 17, for nylon 11 the minimal warpage observed for the sinusoidal prints was 1.5 mm at 60 m/s print speed and 250° C. nozzle temperature. For the control case with these same parameters, the best part had a warpage of 2.25 mm, illustrating a reduction of 33% for the sinusoidal part. The best control case part had a warpage of 2 mm, again at 250° C. nozzle temperature but at a very slow speed of 20 mm/s, and compared to this part, the best sinusoidal part still had a reduction in warpage of 25%.

Thus, consistently on the desktop scale both with neat PP and PA 11, the present method of implementing the sinusoidal toolpath outperformed the base control case. The average warpage deflection of the control parts was 10.42 mm for PP and 6.06 mm for PA 11, whereas for the sinusoidal parts the average warpage deflections were only 3.33 mm and 3.83 mm corresponding to a reduction of 68% and 37%, respectively.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of depositing material for additive manufacturing of an object, the method comprising:
providing a printhead configured to move linearly along a flat x-y plane parallel to a build surface for the object and configured to simultaneously move in a vertical z-direction that is perpendicular to the x-y plane; and
forming a layer of the object by extruding material from the printhead while simultaneously operating the printhead to move in a printing pattern that includes both a linear component in the x-y plane and a vertical component in the z-direction to deposit a layer of material along a path of the printing pattern;
wherein the printing pattern is one of: i) sinusoidal; ii) sinusoidal-like; iii) partially sinusoidal, or iv) partially sinusoidal-like;
wherein the printing pattern compensates for material contraction upon solidification of the formed object, thereby reducing one or both of residual stress in the formed object and distortion of the formed object.

2. The method of claim 1, wherein the layer comprises one of a plurality of iteratively deposited layers of an additive build that is formed according to a three-dimensional model, such that the additive build is comprised of successive layers that form the object.

3. The method of claim 1, wherein the printing pattern is a sinusoidal-like pattern that is a sawtooth pattern.

4. The method of claim 3, wherein the sawtooth pattern comprises linear peaks and linear valleys alternating between ramped portions.

5. The method of claim 1, wherein the printing pattern is a partially sinusoidal pattern that comprises a linear component and a sinusoidal component.

6. The method of claim 5, wherein the partially sinusoidal printing pattern includes a plurality of alternating linear components and sinusoidal components.

7. The method of claim 1, wherein the printing pattern is a partially sinusoidal-like pattern that comprises a linear component and a sinusoidal-like component.

8. The method of claim 7, wherein the sinusoidal-like pattern is a sawtooth pattern.

9. The method of claim 7, wherein the partially sinusoidal-like printing pattern includes a plurality of alternating linear components and sinusoidal-like components.

10. The method of claim 1, further comprising the step of controlling movement of the printhead to adjust one or both of a frequency and an amplitude of the printing pattern.

11. The method of claim 10, wherein the deposited layer is one layer of a plurality of iteratively deposited layers of an additive build according to a three-dimensional computer model, such that the additive build is comprised of successive layers of the deposited material; and
wherein the step of controlling movement of the printhead includes decreasing the amplitude of the printing pattern for each successively deposited layer of the additive build.

12. The method of claim 10, wherein the amplitude of the printing pattern is smaller than a bead height of the deposited material.

13. The method of claim 1, wherein the material comprises a polymer, a polymer composite, a metal, a metal alloy, or a metal/alloy composite.

14. The method of claim 1, wherein the material comprises one of: i) polyethylene; ii) polypropylene; iii) nylon 11; iv) nylon 6; v) nylon 66; vi) polylactic acid; or vii) acrylonitrile butadiene styrene.

15. An additive manufacturing device comprising a printhead, wherein the printhead is configured to perform the method of claim 1.

16. A method of operating an extrusion printhead to perform an additive manufacturing process, the method comprising:
operating an actuator with a controller to move one or both of the printhead and a build surface relative to each other, wherein the printhead travels along a predetermined path for one layer of a three-dimensional printed object; and
while moving the printhead, depositing material along the predetermined path to form said one layer in a printing pattern, wherein the printing pattern includes both a linear component in an x-y plane parallel to the build surface and a vertical component in a z-direction perpendicular to the build surface;
wherein the predetermined path compensates for material contraction upon solidification of the printed object, thereby reducing one or both of residual stress in the printed object and distortion of the printed object.

17. The method of claim 16, wherein said one layer is one of a plurality of iteratively deposited layers of an additive build according to a three-dimensional computer model, such that the additive build is comprised of successive layers of the deposited material that form the printed object.

18. The method of claim 16, wherein the additive manufacturing process is one of fused deposition modeling, fused filament fabrication, or melt extrusion deposition.

19. The method of claim 16, wherein the printing pattern is one of: i) sinusoidal; ii) sinusoidal-like; iii) partially sinusoidal, or iv) partially sinusoidal-like.

20. The method of claim 16, wherein the material comprises a polymer, a polymer composite, a metal, a metal alloy, or a metal/alloy composite.

21. The method of claim 16, wherein the material comprises one of: i) polyethylene; ii) polypropylene; iii) nylon 11; iv) nylon 6; v) nylon 66; vi) polylactic acid; or vii) acrylonitrile butadiene styrene.

22. The method of claim 16, wherein the printhead is configured to move in the x-direction, the y-direction, and the z-direction for depositing the material in the printing pattern.

23. The method of claim 16, wherein the printhead is configured to move in the x-direction and the y-direction, and cooperative with the printhead, the build surface is configured to move in the z-direction, for depositing the material in the printing pattern.
